(19) United States
(12) Patent Application Publication
(10) Pub. No.: US 2026/0225314 A1
(43) Pub. Date: Aug. 6, 2026

(54) BUILD MATERIAL SUPPLY SYSTEMS FOR APPARATUS FOR THE LAYERWISE MANUFACTURE OF 3D OBJECTS AND METHOD OF BUILD MATERIAL TRANSPORT

(71) Applicant: Stratasys Powder Production Ltd., Nottingham (GB)

(72) Inventors: Anders HARTMANN, Nottingham (GB); Frederik Walsted TJELLESEN, Nottingham (GB)

(21) Appl. No.: 19/147,211

(22) PCT Filed: Jan. 10, 2024
(86) PCT No.: PCT/GB2024/050053

§ 371 Date: Jul. 10, 2025

(30) Foreign Application Priority Data
Jan. 11, 2023 (GB) 2300418.7

(51) Int. Cl. B29C 64/321; B22F 10/80; B22F 12/50; B22F 12/90; B29C 64/386; B33Y 40/00; B33Y 50/00

(52) U.S. Cl. CPC B29C 64/321; B22F 10/80; B22F 12/50; B22F 12/90; B29C 64/386; B33Y 40/00; B33Y 50/00

(57) ABSTRACT

A build material supply system for the layerwise manufacture of 3D objects. The system includes a dosing device, a buffer tank, an excess return chamber, a supply tank, a build material pump, and a controller. An inlet of the build material pump is coupled to the supply tank, excess return chamber, and buffer tank via individual valves. The outlet of the pump is coupled to the buffer tank and the dosing device via additional valves. The controller is configured to close certain valves, to open other valves, and to operate the pump to allow build material to flow from the buffer tank to the dosing device, allow fresh build material to flow from the supply tank into the buffer tank, and allow excess build material to flow from the excess return chamber into the buffer tank. A method of transporting build material through the build material systems is also provided.

### FIELD OF THE INVENTION

The present disclosure relates to build material supply systems for an apparatus for the layerwise manufacture of three-dimensional (3D) objects from build material wherein build material surplus to layer formation is recycled in situ. A method of transporting build material through the build material supply system and a controller therefor are also disclosed.

### BACKGROUND

As additive manufacturing technologies continue to evolve, ever more challenging applications require new solutions. Repeatability and reliability of the mechanical and visual quality of objects over a build process requires consistency in the properties of build material for each layer of an object to ensure that the thermal process to which the layers are subjected remains the same. A change in the property of build material due to for example ageing can affect the melting temperature of the build material and lead to overheating or underheating of the fused layers in powder bed fusion processes. In apparatus in which build material is recycled in situ, it is particularly important to maintain a consistent mixture of recycled build material to fresh build material. A further challenge is to maintain the build material in a free flowing state before use for layer formation so as to allow reliable dosing and to ensure that a layer of uniform density and thickness can be formed. Various build material supply systems are known, such as feed bed and auger fed systems. In such systems, build material is typically not mixed nor recycled in situ, but instead is collected as waste, removed from the apparatus, reconditioned and mixed before being provided back to the apparatus for a new build process. Known apparatus apply in situ recycling by transporting build material by augers and other rotary components. However, these are difficult to service and may not transport all types of powders well. Other apparatus applying in situ recycling use build material pumps but do not adequately manage build material from different sources. Therefore, improvements are still needed to provide build material supply systems suitable for industrial and sustainable processing of objects.

### SUMMARY

The invention is set out in the appended independent claims, while particular embodiments of the invention are set out in the appended dependent claims.

### BRIEF DESCRIPTION OF THE DRAWINGS

Reference is now directed to the drawings, in which:

FIG. 1 is a block diagram of flow paths of build material through a build material supply system according to a first embodiment of the invention;

FIG. 2 is a block diagram of a flow path of build material through a build material supply system according to a second embodiment of the invention;

FIGS. 3A-3D illustrate the various flow paths of a variant of FIG. 1;

FIG. 4 is a schematic cross-section through a build material recirculation system with a flow path according to FIG. 1;

FIG. 5 shows a variant of the system of FIG. 3 suitable for the flow path of FIG. 3D;

FIG. 6 is a 3D illustration of the exterior of a buffer tank;

FIGS. 7A and 7B are schematic cross sections of a variant of FIG. 6;

FIGS. 8A to 8D are 3D illustrations of an implementation of a buffer tank interior;

FIG. 9A is a 3D representation of a variant of a dosing device with a build material bypass;

FIGS. 9B and 9C are different 3D cuts through the dosing chamber and bypass of FIG. 9A;

FIG. 10 is a variant of FIG. 1 for a flow path comprising the dosing device of FIG. 9A-9C;

FIG. 11 is a variant flow path of FIG. 10;

FIGS. 12A to 12D schematically illustrate apparatus suitable for implementing the flow path according to FIG. 2;

FIG. 13 is a variant of the block chart of FIG. 2; and

FIG. 14 is a flow chart of a method of operation according to the invention.

In the drawings, like elements are indicated by like reference numerals throughout.

### DETAILED DESCRIPTION

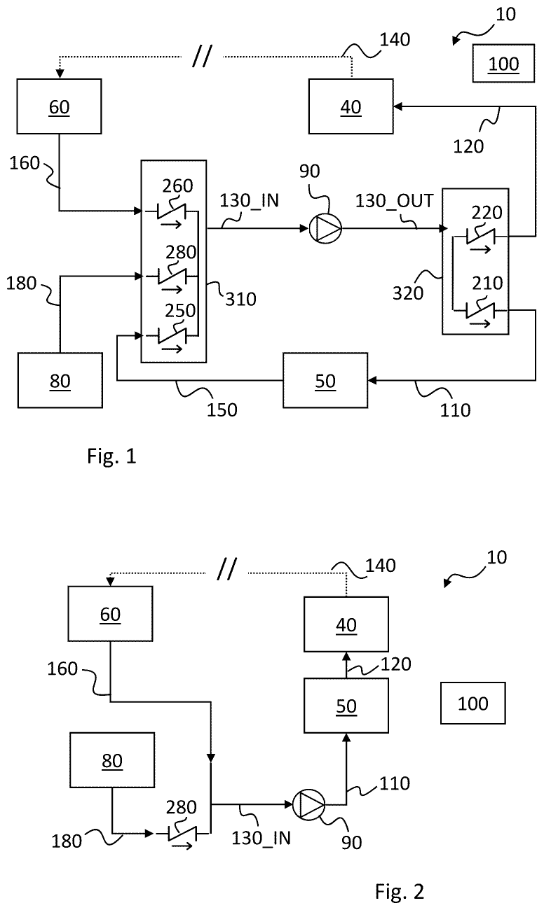

Build material supply systems and their method of use according to the invention for apparatus for the layerwise manufacture of 3D objects from build material, wherein the build material supply systems allow in situ reuse of build material surplus to forming a layer, and their variants will be described with reference to FIGS. 1 to 14.

In a first embodiment and with reference to FIG. 1, which is a block diagram of flow paths of build material through a build material supply system 10 according to a first embodiment of the invention, the build material supply system 10 comprises: a dosing device 40 configured to supply a dosed amount of build material to a work surface of the apparatus, the dosed amount comprising a layer amount and an excess amount surplus to forming the layer; a buffer tank 50 configured to mix build material for supplying to the dosing device 40; an excess return chamber 60 for receiving excess build material; a supply tank 80 for holding fresh build material for replenishing the buffer tank 50; a build material pump 90 for transporting build material within the build material supply system 10; and a controller 100. An inlet of the build material pump 90 is coupled to the supply tank 80 via a first valve 280, to the excess return chamber 60 via a second valve 260, and to the buffer tank 50 via a third valve 250; and an outlet of the build material pump 90 is coupled to the buffer tank 50 via a fourth valve 210 and to an inlet of the dosing device 40 via a fifth valve 220. The controller 100 is coupled to the build material pump 90 and to the said valves, and is configured to control the third valve 250 and the fifth valve 220 to close so as to at least shut off a dosing flow path from the buffer tank 50 through the pump 90 to the dosing chamber 40, optionally to control the first valve 280 to close so as to optionally shut off a supply flow path from the supply tank 80 through the pump 90 to the buffer tank 50; control the second valve 260 and the fourth valve 210 to open to open an excess return flow path from the excess return chamber 60 through the pump 90 and into the buffer tank 50, and control the pump 90 to operate. This allows excess build material to flow along the excess return flow path, for example over a predefined excess return duration or based on a minimum excess build material level sensed within the excess return chamber 60.

Furthermore, the controller 100 is configured to control the third valve 250 and fifth valve 220 to close to shut off the dosing flow path, to control the first valve 280 and the fourth valve 210 to open, and the pump to operate. This allows fresh build material to flow along a supply flow path from the supply tank 80 through the pump 90 and into the buffer tank 50, for example for a fill duration of time or based on reaching a fill level sensed within the buffer tank 50.

Furthermore, the controller 100 is configured to control the first valve 280, the second valve 260 and the fourth valve 210 to close so as to shut off the supply flow path and the excess return flow path, to control the third valve 250 and the fifth valve 220 to open, and the pump 90 to operate. This allows build material to flow along the dosing flow path, for example for a dosing duration of time or based on a reaching a predefined dosing level within the dosing device 40.

Thus, the amount of fresh build material transported into the buffer tank 50 compared to the excess amount of build material transported into the buffer tank 50 may be controlled. Furthermore, it may be ensured that the build material in the buffer tank 50 is replenished with fresh material to replace the layer amount removed from the build material supply system 10 to form a layer.

In a second embodiment and with reference to FIG. 2, which is a block diagram of flow paths of build material through a build material supply system 10 according to a second embodiment of the invention, the build material supply system 10 comprises a dosing device 40 configured to supply a dosed amount of build material to a work surface of the apparatus, the dosed amount comprising a layer amount and an excess amount surplus to forming the layer; a buffer tank 50 configured to mix build material for supplying to the dosing device 40; an excess return chamber 60 for receiving excess build material from a distribution device; a supply tank 80 for holding fresh build material for replenishing the buffer tank 50; a build material pump 90 for transporting build material within the build material supply system 10; and a controller 100. An inlet of the pump 90 is coupled to the supply tank 80 via a first valve 280, and to an outlet of the excess return chamber 60. An outlet of the pump 90 is coupled to an inlet of the buffer tank 50; and an outlet of the buffer tank 50 is coupled to an inlet of the dosing device 50. Thus, in this embodiment, the buffer tank provides build material direct into the dosing device 40, and not via the pump 90. The controller 100 is coupled to the pump 90 and the first valve 280, and is configured to, optionally, control the first valve 280 to be closed so as to optionally shut off a supply flow path from the supply tank 80 through the pump 90 to the buffer tank 50; and to operate the pump 90. This allows excess build material to flow along an excess return flow path from the excess return chamber 60 through the pump 90 and into the buffer tank 50, for example over a predefined excess return duration or based on a minimum excess build material level sensed within the excess return chamber 60.

Furthermore, the controller 100 is configured to control the first valve 280 to open the supply flow path and the pump 90 to operate to allow fresh build material to flow along a supply flow path, for example for a fill duration of time or based on reaching a predefined fill level sensed within the buffer tank 50. Since in the second embodiment, build material is provided to the dosing chamber direct from the buffer tank and not via the pump 90, outlet valves between pump and buffer tank are not needed.

Thus, the amount of fresh build material transported into the buffer tank 50 compared to the excess amount of build material transported into the buffer tank 50 may be controlled. Furthermore, it may be ensured that the build material in the buffer tank 50 is replenished with fresh material to replace the layer amount removed from the build material supply system 10 to form a layer.

In both embodiments, the controller may be configured to control the dosing of the dosed amount from the dosing device. In both embodiments, the buffer tank 50 may comprise a sensor configured to detect a fill level of build material within the buffer tank 50, and the controller may be configured to receive the sensed fill level from the sensor and to open the supply flow path upon determining that the sensed build material level is below a predetermined threshold level.

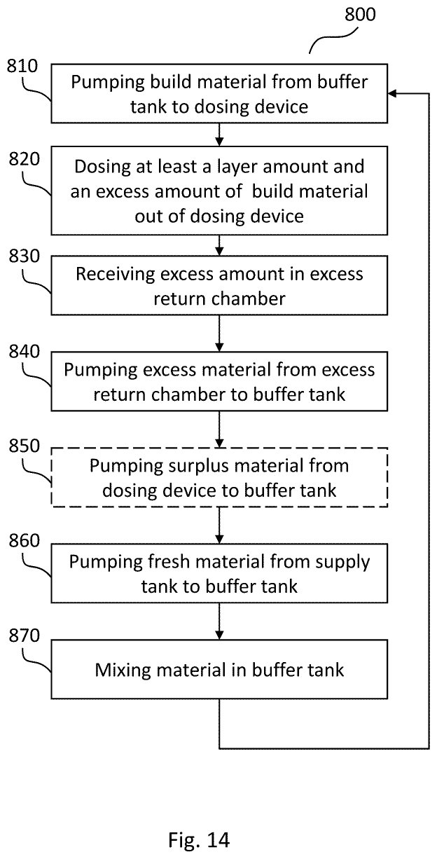

Also provided, with reference to the flow diagram of FIG. 14, is a method 800 of transporting build material through the build material supply systems 10 of the first and second embodiments, the method comprising:
(a) at block 810, operating a build material pump 90 while opening a dosing flow path, from a buffer tank 50 to a dosing device 40, to transport build material from the buffer tank 50 to the dosing device 40. This may be applied over a predefined dosing flow duration, or until the build material level in the dosing device 40 has reached a predetermined dosing level.
(b) at block 820, dosing a dosed amount of build material to a work surface of an apparatus, the dosed amount comprising a layer amount for forming a layer and an excess amount surplus to forming a layer. The repeat frequency of this block defines the cycle time necessary to form a layer;
(c) at block 830, receiving excess build material within an excess return chamber 60;
(d) at block 840, operating the build material pump 90 while opening an excess return flow path to return excess build material from the excess return chamber 60 to the buffer tank 50. This may be applied over a predefined excess return duration, or until the build material level in the excess return chamber 60 has fallen below a predefined minimum level.
(e) at block 860, operating the build material pump 90 while opening a supply flow path from a supply tank 80 to the buffer tank 50, to transport build material from a supply tank 80 to the buffer tank 50, until either a predetermined fill duration has passed or until detecting that the level of build material in the buffer tank 50 has reached a predefined fill level; and
(f) at block 870, mixing the excess amount with the build material in the buffer tank 50. The method may comprise detecting one or more of a fill level of build material in the buffer tank 50, an excess build material level in the excess return chamber 60, and/or a dosing level of build material in the dosing device. Optionally, steps (a) to (d) at blocks 810 to 840 may be repeated one or more times, or until a predetermined duration has passed, or until detecting that the level of build material in the buffer tank and/or the excess return chamber has fallen below a respective threshold level, before proceeding to step (e) at block 860 to replenish the buffer tank with fresh build material. Not each of the steps at blocks 840 to 860 may be present in each cycle.

The build material systems and method of transporting build material therethrough may be particularly beneficial in apparatus in which excess return build material may have undergone a degree of ageing and change in properties, for example in which the excess return amount is subjected to heating to near the melting temperature as it is being transferred across the work surface and build surface of the apparatus. The provision of a buffer tank 50 in addition to the supply tank 80 allows, by suitable operation of the flow paths and valves, to maintain a build material mixture with consistent properties throughput the build process by controlling the ratio of excess build material and fresh build material flowing into the buffer tank. Excess build material in the case of powder bed fusion processes experiences relatively high processing temperatures near to the melting temperature of the material, and may have undergone degradation. While the in situ reuse of excess build material increases the use rate of build material, it is important to ensure that degraded material is fed back in a manner that ensures that it does not affect the overall properties of the build material in the buffer tank 50 throughout the build process. Thus, excess build material may be fed back into the buffer tank 50 together with fresh build material from the supply tank 80 in a controlled, cyclical manner to ensure that the build material mixture within the buffer tank 50 remains substantially consistent throughout a build process. This would not be possible with a single tank. Furthermore, the buffer tank 50 is arranged to mix the build material, thus providing homogenous build material of consistent properties to the dosing device. The supply tank 80 as disclosed herein may not require mixing functionality. The step (f) at block 870 of mixing may be applied continuously throughout the disclosed blocks of the method.

In some of the following drawings, the controller 100 is not shown but equally applies as described herein.

### Variants of the First Embodiment

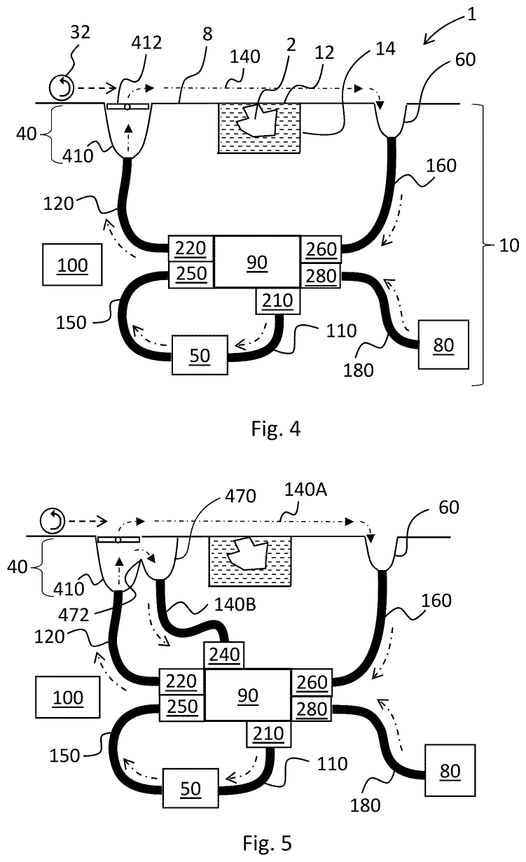

An example of a 3D printing apparatus in the form of a powder bed fusion type apparatus configured to reuse build material in situ and comprising a variant of a build material supply system according to the first embodiment will be described with reference to FIG. 4. FIG. 4 is a schematic cross section of a side view of components of the apparatus 1 comprising the build material supply system 10 described with respect to FIG. 1. It should be noted that in FIG. 4, the distribution path 140 is illustrated from left to right, and thus the dosing device 40 and the return chamber 60 are now on the respective left and right of the build area, in a mirror image representation of that shown in FIG. 1 and FIG. 2. Build material mixed and of a composition suitable for forming layers is provided to a buffer tank 50. The dosing device comprises a dosing chamber provided below the work surface 8 of the apparatus. The work surface comprises a build area 12, the build area 12 being the top most surface of a build volume 14, supported on a build platform within container walls (not shown), and comprising completed cross sections of the object 2 to be formed. The dosing device comprises a dosing outlet within the work surface and over which a dosing blade 412 is rotatably provided. Further provided at a side of the build area opposite to that at which the dosing outlet is located is an excess return chamber 60. From the dosing chamber 410, an amount of build material is dosed to the work surface by rotating a dosing blade to scoop a dosed amount of build material from within the dosing chamber 410, and to hold the dosed amount above the work surface. A spreading device 32, here illustrated as a roller, is moved from left to right to spread the dosed amount of build material along a distribution path 140.

The buffer tank 50 is configured to mix the build material, intermittently or continuously, so as to keep the build material in a homogenous, and preferably free flowing, state. The inlet valves and outlet valves indicated by blocks are coupled to the pump and are labelled as for FIG. 1. The controller 100 may control the valves so as to open the dosing flow path, comprising a buffer tank to pump section 150 and a pump to dosing device section 120, to allow build material to flow from the buffer tank through the pump 90 and to the dosing chamber 410. The dosed amount comprises an excess amount of build material that prevents short feed and which is pushed by the distribution device 32 of the apparatus into an excess return chamber 60. It should be noted that the dosed amount comprising a layer amount and an excess amount surplus to forming the layer may comprise a further amount that is spread over the work surface outside of the build area, for example.

The controller may control the valves to open the excess return flow path along an excess return to pump section 160 and the pump to buffer tank section 110 to allow the excess build material to travel back to the buffer tank 50. The controller 100 may control the valves to open the supply flow path along a supply tank to pump section 180 and the pump to buffer tank flow section 110 so as to allow fresh build material to flow into the buffer tank 50. Thus the apparatus comprising the build material supply system 10 provides for the immediate in situ reuse of excess build material during a build process of the apparatus.

A variant of the apparatus of FIG. 4 is shown in FIG. 5, in which the dosing device 40 further comprises an overflow chamber 470 connected to the dosing chamber 410 via an overflow outlet 472 which is arranged below the level of the dosing outlet. As the dosing chamber fills with build material from the dosing path 120, 150 and reaches the level of the overflow outlet, oversupplied build material flows through the overflow outlet 472. This arrangement of dosing device 40 allows the amount of build material in the dosing chamber to be self-regulating, or passively regulated, and ensures that a consistent amount of build material may be dosed to the work surface 8 for each layer. The build material transferred out of the dosing chamber splits into the dosed amount and the oversupply amount, flowing along a first path 140A (distribution path) towards the excess return chamber and along overflow return path comprising the overflow to pump flow path section 140B and the pump to buffer flow path section 110. All other components are as described and referenced for FIG. 4. The overflow amount may be immediately returned to the buffer tank 50 via the oversupply return flow path.

The build material transport mechanism in FIGS. 4 and 5 is thus provided in the form of a build material pump 90, such as a diaphragm pump, and a system of valves to allow opening and shutting the flow paths described herein. This build material supply system 10 may advantageously be applied instead of auger and rigid pipe systems to efficiently move the build material along the flow paths including the dosing flow path, excess return flow path, supply flow path and optional overflow return flow path. Build material supply systems using augers and rigid pipes can be difficult to seal and access, can be prone to failure as result of local compaction of build material, for example after idle time, or intake of small objects, and can be difficult to maintain and repair.

The build material supply systems disclosed herein and their methods of operation according to the invention have been found to allow a reliable supply of mixed build material of substantially stable homogenous consistency to the dosing device 40, by configuring the supply system such that the pump 90 delivers a steady flow of excess return build material and fresh build material, and optionally of overflow build material, to the buffer tank 50.

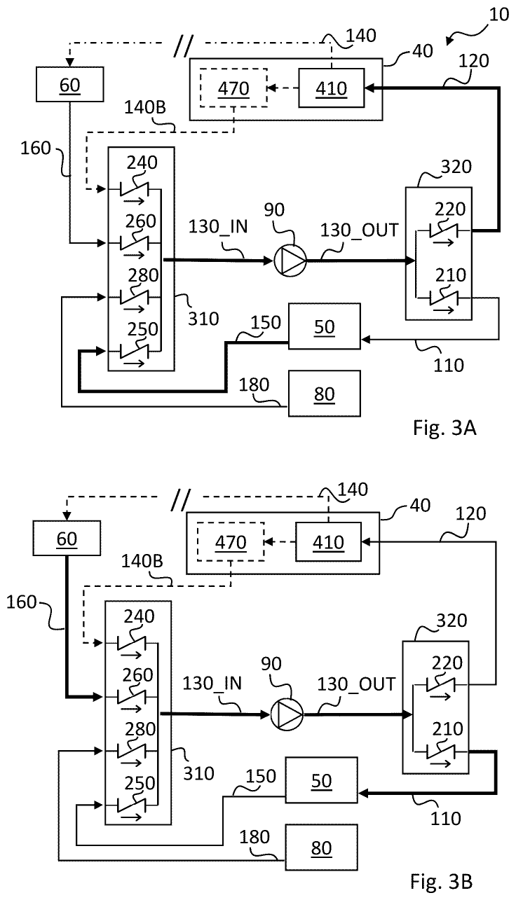

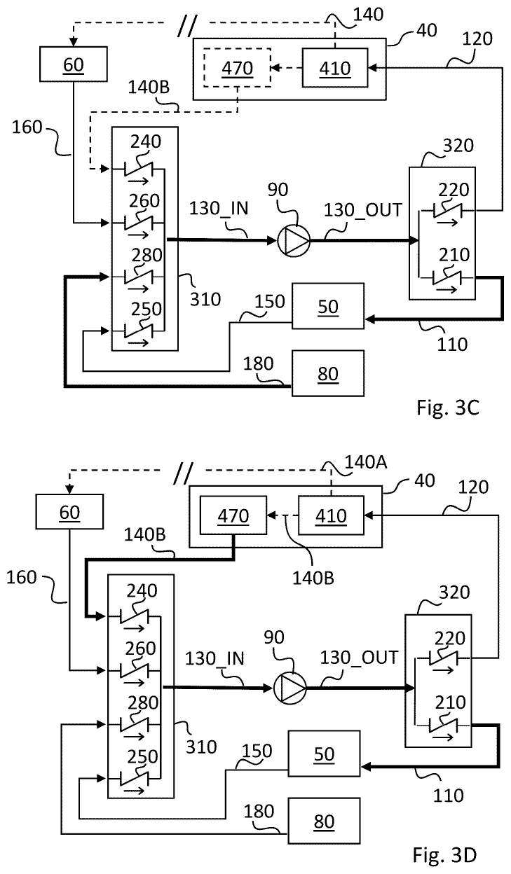

Turning next to FIGS. 3A to 3D, the flow paths of the build material supply systems of FIG. 4, and with the option of the overflow chamber 470 of FIG. 5, are illustrated. The components of the build material supply system of FIG. 4 and FIG. 5 are shown schematically in the form of blocks, with arrows between blocks indicating the direction of the flow along the various paths. For simplicity, the controller 100 of FIG. 1 is not shown but is equally coupled to the valves and the pump, and is configured to control the pump operation and the open and close positions of the valves within the build material flow paths.

In FIGS. 3A to 3D, the flow paths in bold outline indicate open flow paths through which build material is allowed to flow, and flow paths in normal outline indicate closed paths through which build material is not allowed to flow.

FIG. 3A illustrates a variant of FIG. 1 in which the overflow chamber 470 is optional, as indicated by the dashed outline. The build material supply system 10 comprises a first group 310 of at least three inlet valves 250, 260, 280 between a respective one of the buffer tank 50, the excess return chamber 60 and the supply tank 80 and the pump. Each inlet valve may be individually connected to the pump via a dedicated inlet flow path, or may be coupled to a combined inlet flow path 130_IN as shown here. A second group 320 of outlet valves 210, 220 are arranged between the outlet of the pump 90 and the buffer tank 50 and the dosing device 40, respectively. Each outlet valve may be individually connected to the pump via a dedicated outlet flow path, or may be coupled to a combined outlet flow path 130_OUT as shown here. The controller is coupled to the first valve 280, the second valve 260, and the third valve 250, all of which are inlet valves to control the flow of build material into the pump 90. The controller is further coupled to the fourth valve 210 and the fifth valve 220, which are outlet valves to control the flow of build material out of the pump 90.

FIG. 3A indicates in bold the dosing flow path. For the dosing flow path to be open while ensuring that the mixture of excess return and fresh build material remains consistent within the buffer tank, the inlet valves 260 and 280 between the excess return chamber 60 and the supply tank 80, respectively, and the pump 90 are closed and the inlet valve 250 between the buffer tank 50 and the pump 90 is open. The outlet valve 210 between the pump to the buffer tank 50 is closed, and the outlet valve 220 between the pump and the dosing device is open. When the pump is controlled to operate, build material is caused to flow from the buffer tank 50 through the pump and into the dosing chamber 410 of the dosing device 40.

FIG. 3B indicates in bold the excess return flow path. For the excess return flow path to be open, the inlet valves 250 and 280 between the buffer tank 50 and the supply tank 80, respectively, and the pump 90 are closed and the inlet valve 260 between the excess return chamber 60 and the pump 90 is open. The outlet valve 220 between the pump and the dosing device is closed, and the outlet valve 210 between the pump to the buffer tank 50 is open. When the pump is controlled to operate, build material is caused to flow from the excess return chamber 60 through the pump 90 and into the buffer tank 50.

FIG. 3C indicates in bold the supply flow path. For the supply flow path to be open, the inlet valves 250 and 260 between the buffer tank 50 and the excess return chamber 60, respectively, and the pump 90, are closed, and the inlet valve 280 between the supply tank 80 and the pump 90 is open. The outlet valve 220 between the pump and the dosing device is closed, and the outlet valve 210 between the pump to the buffer tank 50 is open. When the pump is controlled to operate, fresh build material is caused to flow from the supply tank 80 through the pump 90 and into the buffer tank 50.

Turning to FIG. 3D, where a variant of the build material supply system 10 further comprises the overflow chamber 470 coupled to the dosing chamber 410 as illustrated in FIG. 5, the first group of inlet valves further comprises a sixth valve 240 between the overflow chamber 470 and the pump 90. The flow from the dosing chamber 410 to the overflow chamber 470 is indicated schematically by the flow path section 140B flowing out of the dosing chamber 410 and continuing through the overflow chamber 470 and to the sixth valve 240.

FIG. 3D indicates in bold the overflow return flow path. For the overflow return flow path to be open, the inlet valves 250, 260 and 280 between the buffer tank 50, the excess return chamber 60 and the supply tank 80, respectively, and the pump 90 are closed, and the inlet valve 240 between the overflow chamber 470 and the pump 90 is open. The outlet valve 220 between the pump and the dosing device is closed, and the outlet valve 210 between the pump to the buffer tank 50 is open. When the pump is controlled to operate, build material is caused to flow from the overflow chamber 470 through the pump 90 and into the buffer tank 50.

Thus the dosing device of the build material supply system of the first embodiment may comprise a dosing chamber 410 coupled to the outlet of the pump and configured to receive build material from the buffer tank 50 via the pump 90; the dosing device 40 further comprising an overflow chamber 470 coupled to the dosing chamber 410 and configured to receive an oversupply amount of build material transferred from the buffer tank 50 to the dosing chamber 410 when the build material in the dosing chamber reaches a predefined level; wherein the overflow chamber 470 is coupled to the inlet of the pump 90 via a sixth valve 240, and wherein the controller 100 is configured to control at least the third and fifth valves 250, 220 to close so as to shut off the dosing flow path and the sixth valve 240 and the fourth valve 210 to open and the pump to operate to open the oversupply return path from the overflow chamber through the pump to the buffer tank. This allows oversupplied build material to flow along the oversupply return flow path.

Any or all of the inlet valves may be variable valves and operated as will be explained further below. With respect to build material supply systems of variants of the first embodiment comprising an overflow chamber 470, an optional block 850 of the method 800, and as indicated in FIG. 14 by a dashed outline, may comprise operating the build material pump while opening an oversupply return flow path to return oversupply build material from the dosing device to the buffer tank. This may be applied over a predefined overflow return duration, or until the build material level in the overflow chamber has fallen below a predefined minimum level.

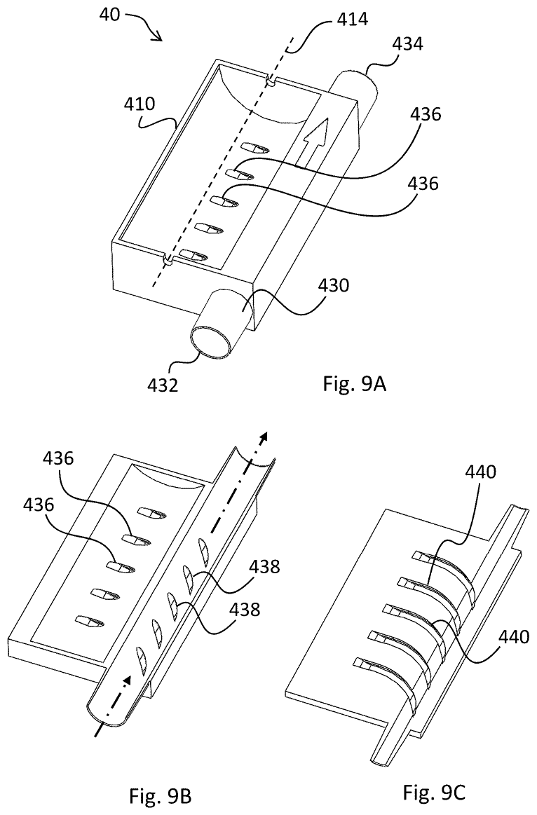

Next, a variant of the dosing device 40 of the first embodiment will be described. One of the challenges of using a build material pump is to reduce or prevent propelling build material into the atmosphere within a dosing device comprising a dosing chamber 410 into which build material is pumped at elevated gas pressure bursts. Furthermore, the pump may be very efficient in supplying large amounts of build material over a short duration of time, such that the amount supplied to the dosing chamber may require careful control, whether by active or passive means. The inventors have thus developed a variant of a dosing device 40 comprising a build material bypass connected to the dosing chamber 410 by multiple dosing chamber inlets that controls the flow of build material into the dosing chamber 410 and significantly reduces or entirely prevents the generation of powder dust in the dosing chamber. FIG. 9A illustrates a 3D view of such a variant of a dosing device 40 from above. The dosing chamber 410 is represented as an elongate trough shaped container configured to comprise a dosing blade (not shown) to be mounted and rotatable about an axis 45. Build material is supplied to the dosing chamber interior from a plurality of inlet ports 436. Each inlet port is connected via an inlet flow path 440 to a bypass outlet port 438. As shown herein, the outlet ports 438 are arranged along the length of an intermediate section of the bypass pipe 430. Each inlet path 440 has a significantly higher flow resistance than the bypass 430; preferably the combined flow resistance of the inlets is larger than the flow resistance of the bypass pipe between its inlet and outlet. As build material is pumped from the bypass inlet 432 through the bypass, it is forced by build material flow into the multiple outlet ports 438 arranged along the length of the intermediate section, each port connected to an inlet 436. The dosing chamber inlets 436 are preferably arranged along a lower portion of the dosing chamber and such that build material enters the dosing chamber along a substantially horizontal direction, or at a tangent to the curvature of the trough, so as to avoid propelling the material into the atmosphere of the dosing chamber and into the work space above. From the bypass outlet 434, the build material may be circulated back into the buffer tank 50. The inlet paths 440 are illustrated in more detail in FIG. 9B and FIG. 9C, which illustrate deeper cuts through the dosing chamber floor to reveal the outlet ports in the bypass chamber 430 and the inlet paths 440. By selecting a suitable flow resistance for the flow paths, for example between each of an intermediate bypass outlet and a corresponding dosing chamber inlet, for example by selecting an appropriate diameter and length of each inlet path 440, it has been found that excessive amounts of fast flowing gas entering the dosing chamber 410 may be prevented. Instead, the gas may predominantly or entirely flow along the bypass chamber 430 and out of the bypass outlet 434.

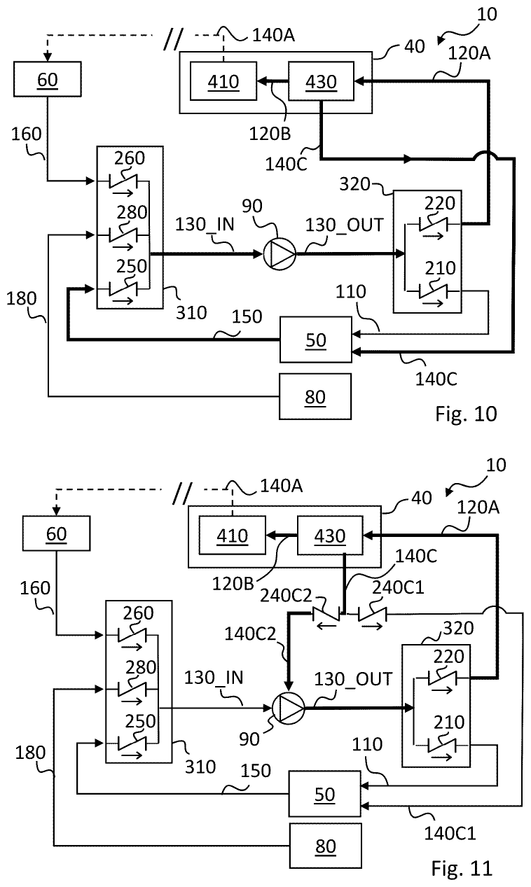

Therefore, provided is a dosing device 40 comprising a dosing chamber 410 and a build material bypass chamber 430. The dosing chamber 410 comprises one or more build material inlet 436 coupled to one or more intermediate outlets 438 of an intermediate section of the bypass chamber 430, wherein the intermediate section is arranged between a bypass chamber inlet 432 and a bypass chamber outlet 434. The bypass chamber inlet 432 is configured to receive build material from a build material source, such as the buffer tank 50, and the bypass chamber outlet 434 is configured to release build material from the bypass chamber 430. The one or more intermediate outlets 438 are connected to the one or more dosing chamber inlets 436 via one or more dosing chamber inlet paths 440 representing the combined flow path 120B that will be described below with reference to FIGS. 10 and 11. The dosing chamber inlet paths 440 are configured to present a flow resistance to build material flow that is higher than the flow resistance of the bypass chamber 430 between the inlet and the outlet 432, 434 of the bypass chamber. Furthermore, the combined flow resistance of a plurality of dosing chamber inlet paths 440, each dosing chamber inlet path 440 arranged between an outlet port 438 and dosing chamber inlet 436, may be higher than the flow resistance of the bypass chamber between the inlet 432 and the outlet 434 of the bypass chamber 430. Each of a plurality of outlet ports 438 may be connected to a respective dosing chamber inlet 436. The one or more dosing chamber inlets 436 may be arranged near a gravitationally lower section of the dosing chamber 410, for example at or near the gravitational bottom of the dosing chamber 410, and/or may be arranged to provide a flow of build material into the dosing chamber at an angle having a parallel component to an inner wall of the dosing chamber. For example, the dosing chamber inlets 436 may be arranged to point along or towards the bottom of the dosing chamber 410. In this way, the generation of build material suspended in the atmosphere of the dosing chamber may be reduced.

Furthermore, self-regulation of the amount of build material supplied to the dosing chamber 410 may be achieved by balancing the flow path resistance between each outlet port 438 and corresponding dosing chamber inlet 436 against a fill level above the inlet level within the dosing chamber. In addition, or instead, the fill level may reach the underside of the dosing blade, which during filling may be in the horizontal position and closing off the dosing outlet to the work space. The dosing blade may be used to provide a resistive force to the flow through the dosing chamber inlets so as to block them against supplying further build material. Alternatively, for some build materials, the weight of the build material may itself be used, as the build material inside the dosing chamber will eventually obscure the inlets 436 and increase the flow resistance beyond a maximum flow resistance that stops the flow through the inlet paths 440. A build material level sensor may be provided in the dosing chamber and connected to the controller so as to allow the controller to close off the dosing flow path when the sensor detects that a predefined fill level has been reached. Alternatively, the dosing chamber 410 may further comprise an overflow outlet coupled to an overflow chamber 470 as described herein with reference to FIG. 3D and FIG. 5. Such approaches may be applied to passively regulate the amount of build material in the dosing chamber 410 to be at a predetermined fill level and thus may allow a continuous circulation of build material along the pump to dosing path 120 without overfilling the dosing chamber. Alternatively, build material may be passed through the bypass 430 intermittently to supply a predefined amount of build material to the dosing chamber over a given number of layer cycles.

Typically, the length of the dosing chamber 410 (along the rotation axis of the dosing blade) is the same as or exceeds the width of the build area 12, the width being parallel to the axis of the dosing blade and perpendicular to the direction of distribution by the distribution device. It may be beneficial that build material inside the dosing chamber 410 is evenly distributed along the length direction, such that the dosed amount dosed to the work surface is evenly distributed along the side of build area. As shown, a plurality of dosing chamber inlets 436 may be arranged along the length of the dosing chamber, which improves the even distribution of build material inside the dosing chamber 410.

In a further variant of the build material supply system 10 according to the first embodiment, the dosing device 40 may comprise a dosing chamber and a bypass chamber 430, the bypass chamber 430 having a bypass inlet 432 and a bypass outlet 434 at either end of an intermediate section, wherein the intermediate section comprises one or more intermediate outlets 438. Further with reference to FIG. 10, which illustrates a flow path through the variant build material supply system, the bypass inlet 432 is coupled to the outlet of the pump 90 via the fourth valve 210 and the bypass outlet 434 is coupled to the or a further inlet of the buffer tank 50. The dosing chamber 410 may comprise one or more dosing chamber inlets 436 configured to receive build material from the bypass chamber 430 and coupled to the one or more intermediate outlets 438 to form one or more intermediate flow paths 440. The controller controls the third and fifth valves 250, 220 to open, and the first, second and fourth valves 280, 260, 210 to close. As the controller controls the pump 90 to operate, build material is caused to flow along the dosing flow path from the buffer tank 50 through the pump 90 to the bypass chamber 430 and along the intermediate flow paths 440, indicated as combined flow path 120B in FIG. 10, from the bypass chamber 430 to the dosing chamber 410. Furthermore, an oversupply amount is caused to flow from the bypass chamber 430 along an oversupply return flow path 140C from the bypass chamber directly to the buffer tank 50 along a direct bypass return path 140C. The open dosing flow path and oversupply return path are indicated in bold.

Preferably, the one or more intermediate flow paths are configured to have a flow resistance that is substantially higher than the flow resistance from the bypass inlet to the bypass outlet, such that gas from the pump predominantly flows from the bypass inlet to the bypass outlet. In addition, or instead, the combined flow resistance of the one or more intermediate flow paths may be substantially higher than the flow resistance from the bypass inlet to the bypass outlet, such that gas from the pump predominantly flows from the bypass inlet to the bypass outlet.

In a variant of FIG. 10, shown in FIG. 11, the bypass outlet may further be coupled to the or the further inlet of the buffer tank 50 via a sixth valve 240C1; such that when the controller further controls the sixth valve 240C1 to open, the oversupply amount is caused to flow from the bypass chamber 430 along a direct oversupply return flow path 140C from the bypass chamber directly to the buffer tank 50. This allows the controller to shut off the oversupply return path when opening the supply path and/or the excess return path.

Optionally, as shown in FIG. 11, the bypass outlet may further be coupled to an inlet of the build material pump 90 via a seventh valve 240C2, wherein the controller is coupled to the seventh valve 240C2 and configured to control:
(i) the third, fifth and sixth valves 250, 220, 240C1 to open, while controlling the first, second, fourth and seventh valves 280, 260, 210, 240C2 to close, and the pump to operate, to allow build material to flow along the dosing flow path and to return an oversupply amount of build material from the bypass outlet direct to the buffer tank 50 along a direct oversupply return flow path 140C1, without passing through the pump and shown in bold in FIG. 10. This supplies build material to the bypass chamber 430;
(ii) the first, second, and fourth valves 280, 260, 210 to remain closed, the third and sixth valves 250, 240C1 to close, and the fifth and seventh valves 220, 240C2 to open, and the pump to operate, to allow build material to circulate from the bypass chamber 430 through the build material pump 90 and back to the bypass chamber 430 so as to continue reusing the oversupply amount of build material to fill the dosing chamber along a recirculating oversupply return path 140C2 shown in bold in FIG. 11. This reuses and depletes the build material recirculating through the bypass chamber 430;
(iii) the fifth and seventh valves to close, the pump to operate, and, either sequentially or simultaneously:
   the second and fourth valves 220, 240C2 to open to allow excess build material to flow along the excess return path into the buffer tank 50;
   the first and fourth valves 280, 210 to open to allow fresh build material to flow along the supply flow path into the buffer tank 50; and to repeat steps (i) to (iii).

With respect to build material supply systems of variants of the first embodiment comprising a bypass chamber 430, an optional block 850 of the method 800, and as indicated in FIG. 14 by a dashed outline, may comprise operating the build material pump while opening an oversupply return flow path to return oversupply build material from the dosing device to the buffer tank either directly or via the pump 90. This may be applied over a predefined oversupply return duration, or until the build material level in the bypass chamber has fallen below a predefined minimum level.

Therefore, in a build material system and its variants according to the first embodiment wherein the build material transported to the dosing device at block 810 comprises an oversupply amount of build material, the step (b) at block 820 may further comprise a step (b1) of allowing the oversupply amount to flow out of the dosing device, and a step (b2) at block 850 of operating the pump while opening a further flow path from the dosing device to the buffer tank 50 to return the oversupply amount to the buffer tank 50. The method may comprise returning the oversupply amount directly to the buffer tank 50 wherein the dosing device comprises a bypass chamber 430 as shown in FIG. 10, or returning the oversupply amount to the buffer tank 50 via the sixth valve and the pump 90 as shown in FIG. 3D wherein the dosing device comprises an overflow chamber 470. Optionally, a yet further flow path may be opened sequentially from the bypass chamber 430 to the pump 90 and back to the dosing device 40 to reuse the oversupply amount in the dosing device.

The step (b2) at block 850 may not be applied at each of a plurality of repeats of the cycle from block 810 to 850. Alternatively, block 850 may be applied over a predetermined duration shorter than that of step (d) at block 840, or upon detecting that the level of build material in the buffer tank and/or the excess return chamber has fallen below a respective predetermined level, such that excess build material is returned to the buffer tank for reuse before oversupply build material is returned to the buffer tank.

The method may comprise returning excess build material at block 840 to the buffer tank 50 first, before returning, where present, oversupply material to the buffer tank at block 850, and before transporting fresh build material from the supply tank at block 860; and wherein the step at block 860 is initiated so as to maintain the build material in the buffer tank at a substantially consistent ratio of excess to fresh build material. For example, block 860 may be initiated by the controller upon detecting that the fill level in the buffer tank 50 has reached a minimum fill level.

### Variants of the Second Embodiment

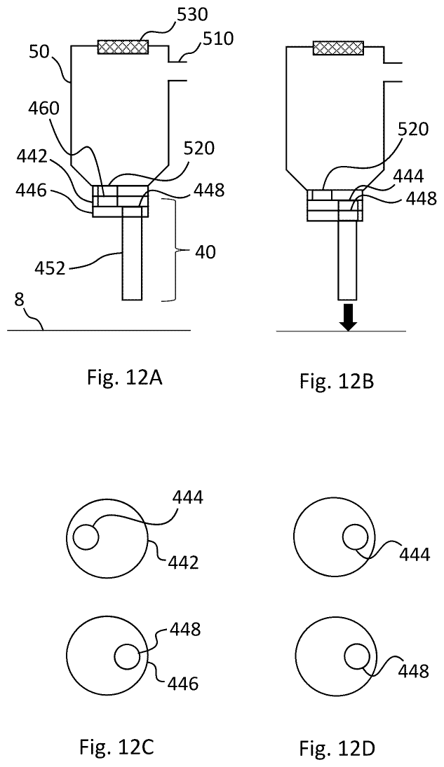

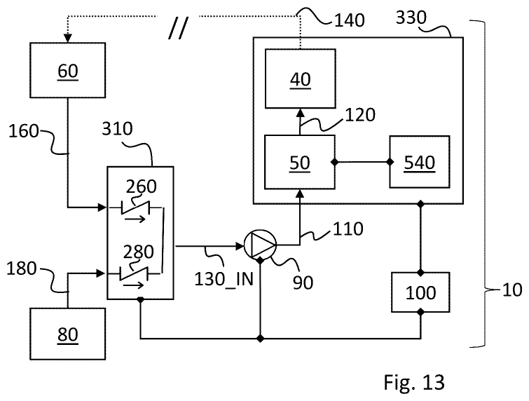

The second embodiment will now we described with reference to FIG. 12A to FIG. 12D and FIG. 13. In an implementation of the second embodiment, build material may be dosed from above the work surface rather than from below, and the dosing device 40 may be directly supplied from the buffer tank 50 without having to pass through the build material pump. As described with reference to FIG. 2, the build material pump 90 is used to transfer build material from the excess chamber 60 and the supply tank 80 to the buffer tank 50 in a similar way as described before and using at least one inlet valve 280 between the supply tank 80 and the pump 90.

FIG. 12A is a schematic cross section of a side view of a buffer tank 50 arranged above the work surface 8. An inlet 510 of the buffer tank 50 is configured to be coupled to an outlet of a supply tank 80 via a first valve and a pump 90 as before, and to an outlet of the excess return chamber 60 as described with reference to FIG. 2. The outlet 520 of the buffer tank 50 may be an aperture in a bottom plate of the buffer tank as shown in FIG. 12A. The buffer tank outlet 520 is coupled to a dosing device 40 equivalent in function to the dosing device described above, and is configured to dose a dosed amount of build material from the buffer tank 50 to the work surface 8, after which a layer amount of the dosed amount is distributed over a build area by the spreading device to form a layer and the excess amount is pushed into the return chamber 60. Various known means may be applied to dose a consistent amount of build material for each layer. In this example dosing device 40, the outlet portion with the buffer tank outlet 520, a rotatable metering disc 442 and a fixed release disc 446 are stacked on top of one another from the top down. These metering disc 442 and the release disc 446 are shown in an offset plan view in FIG. 12C in a metering position when the discs are superimposed. The metering disc is arranged to rotate about a vertical axis central to the metering disc. The metering disc may comprise one aperture 444 as shown and configured to receive build material from the buffer tank through the buffer tank outlet when the metering disc is rotated to bring the aperture 444 into alignment with the buffer tank outlet 520 as shown in FIG. 12A. The release aperture 448 is not aligned with the metering aperture 444. Build material flows through the buffer tank outlet into the metering aperture and when the metering aperture 444 is filled with build material from the buffer tank, the disc is rotated to a release position to bring the metering aperture into alignment with the release aperture 448 while blocking off the buffer tank outlet 520. This is indicated in FIG. 12B with the discs in alignment shown in an offset plan view in FIG. 12D. Build material flows from the metering aperture 444 to the release aperture 448, and from the release aperture through a release portion such as a guide pipe 542 onto the work surface 8. The guide pipe 452 may prevent excessive generation of build material being released to the atmosphere. The discs may comprise more than one aperture such that the build material may be released in a plurality of portions. Additionally, or instead, they may be arranged to release build material at different locations along the length of the spreading device. Other known variants may apply a rotatable bar with opposing grooves in place of the metering and release discs.

This variant of a dosing device 40 eliminates the need of managing the pressurised gas from the pump within the dosing device. Furthermore, the dosed amount is controlled by the metering and release discs without the need to return oversupplied material from an overflow or bypass chamber to the buffer tank. The buffer tank 50 may comprise a build level sensor to refill the buffer tank to the predefined fill level from the excess return chamber and the supply tank as will now be described with reference to FIG. 13.

FIG. 13 is a block chart illustrating a variant of the flow path of FIG. 2 in which a further inlet valve 260 may be provided between the excess return chamber 60 and the pump 90. As described before for the build material supply system 10 of FIG. 2, the buffer tank provides build material direct into the dosing device 40, and not via the pump 90. The arrangement of the build material supply system according to the second embodiment allows providing a homogeneous build material mixture of consistent properties to the dosing device by managing the amounts of excess build material and fresh build material that is being fed into the buffer tank. FIG. 13 is a block chart illustrating the flow of build material through the build material supply system 10, as before with arrows indicating flow direction. The controller 100 is shown coupled to a combined block 330 comprising the dosing device and the buffer tank and a build material level sensor 540, and may be configured to control the dosing device so as to dose the dosed amount. The controller is further coupled to a first group 310 of inlet valves comprising the first valve 280, and may further be configured to control the supply flow path from the supply tank 80 via a first valve 280 through the pump 90 and into the buffer tank 50 by causing the first valve to open and the pump to operate. Thus, build material is allowed to flow into the buffer tank 50 along a flow path section 180 from the supply tank to the first valve; along a common pump inlet section 130_IN and along flow path section 110 from the pump to the buffer tank. The buffer tank 50 is coupled to the dosing device 40, which comprises a dosing chamber in the form of for example an aperture 448.

In this variant of FIG. 2, the group of inlet valves comprises the second valve 260 and the inlet of the pump 90 is coupled to the excess return chamber 60 via the second valve 260. The controller is coupled to the second valve 260 and configured to control the first valve 280 to at least partially close and the second valve 260 to open to allow excess build material to flow along the excess return flow path. After this, the controller may cause the second valve 260 to close and the first valve 280 to open fully to allow fresh material to flow along the supply flow path. Thus the controller is able to control the second valve 260 to shut off the flow path section 160 of the excess return flow path from the excess return chamber to the pump, when controlling the first valve to open. This allows to sequentially cause excess build material to return to the buffer tank and fresh build material to fill the buffer tank. In addition, shutting off the excess return flow path may prevent unintentional suction from the excess return when the first inlet valve 280 between supply tank and pump is open and thus improve control over the ratio of excess return to fresh build material supplied to the buffer tank. It may further allow the pump to be operated to mix the build material in the buffer tank 50 while the first valve is closed. As described for FIG. 12A to 12D, the dosing device may comprise a dosing device inlet in the form of the metering aperture and configured to receive build material from the outlet of the buffer tank, wherein the controller is coupled to the dosing device and configured to control the dosing device to release the dosed amount. The dosing device may release a dosed amount of build material towards the work surface under the action of gravity, for example.

From the two valves, a combined inlet path 130_IN may be provided. Alternatively, the two flow paths may be separately connected to the pump as shown in FIG. 3.

### Prioritisation and Timing of Build Material in Flow Paths

Herein, “fresh” build material may include a predefined mixture of virgin and reused material from a previous one or more build processes, for example 30:70 or 20:80 virgin:reused ratio. For most build materials, due to thermal ageing, it is preferable or required that the virgin:reused ratio supplied to the dosing chamber does not change significantly enough during the build process so as to significantly alter the thermal properties of the build material. In a powder bed fusion process, it is important that the properties of the build material supplied to the dosing chamber and for forming each layer do not change significantly during a build process. A substantial change in the reuse content is likely to alter the thermal properties of the build material, which in turn will lead to different response of the layer of build material to the thermal cycle applied to fuse the layer. For example, the melting temperature of the build material may shift to a higher temperature than the process was calibrated for, and the thermal energy applied to fuse a cross section of the objects within that layer may not cause the same degree of fusion as for previous layers. This may result in progressive changes in mechanical and potentially visual properties of the object. Any significant departure from a reliable uniform process leads to object inconsistencies and thus reduced yield due to rejection of unsuitable objects, and this may be avoided by controlling and timing the amount of build material supplied from the various sources to the buffer tank 50.

Thermal ageing such as in the form of degradation or polymer chain growth may occur when build material experiences elevated temperatures, especially those near the melting point. Nylon PA11 for example has a melting temperate of around 200° C. PA11 build material within the flow paths between valves, and for example within the dosing chamber, may be brought to a temperature of 100-140° C. before being dosed to the work surface 8. As the dosed amount is distributed over the previous build area to form a new layer, it is spread onto the hot surface of the existing build volume, which may be maintained at a build bed temperature of around 180° C. The dosed amount is thus much colder than the build bed temperature, and to prevent warping and curl of the underlying fused cross sections, the new layer is typically preheated immediately to bring it up to or near to the build bed temperature. This may be done by arranging a heat bar, such as an infrared bar lamp, to follow the spreading device to preheat the new layer as it is being formed. The excess amount ahead of the spreading device will also heat up through contact with the underlying build volume and will therefore have experienced the highest thermal impact of the powder within the supply system to the buffer tank. It is generally desirable to reuse the excess build material first. Since the excess amount is typically relatively small compared to that in the buffer tank, it may be returned immediately to the buffer tank and mixed with the buffer tank build material. Meanwhile, in the case of the system of FIG. 4, the main source of build material within the buffer tank may be from the supply tank, which comprises build material with predefined properties. In the case of a system of FIG. 5, which comprises an additional flow path of the dosing overflow 470, the overflow build material may also be returned to the buffer tank 50 before build material from the supply tank 80 is required. The overflow material from the dosing overflow 470 may have had a lower thermal exposure than the excess build material and may be returned to the buffer tank after the excess material is returned to the buffer tank 50.

Herein, the excess overflow chamber, the overflow chamber and the bypass chamber may be configured to hold a certain amount of build material before build material from these chambers needs to be transported to the buffer tank. Therefore, it is possible to transport build material sequentially and apply certain orders and/or flow controls. The build material supply system according to both embodiments may provide for a method of build material transport in which the controller controls the first valve to close to shut off the supply flow path, and to control the pump to operate, and, where present, the second valve to open, to allow the excess build material to flow along the excess return flow path. After this, the controller may control the second valve to close and the first valve to open to refill the buffer tank with fresh build material, thus applying a sequential filling method with improved control over the amounts of excess return and fresh build material transferred into the buffer tank 50. Alternatively, the excess return build material may be returned to the buffer tank at the same time as transporting fresh build material from the supply tank to the buffer tank 50.

With respect to the first embodiment and its variants, to allow excess build material and fresh build material to flow simultaneously along the supply flow path and the excess return flow path, the controller may control the third and fifth valves to close, control the first and second valves 280, 260 to open, and operate the pump. In variants of the first embodiment comprising an overflow chamber 60, the controller may further control the sixth valve 240 to open to allow oversupply build material to flow from the overflow chamber 470 into the buffer tank 50 simultaneously with the excess build material and fresh build material while controlling the third and fifth valves 250, 220 to remain closed to keep the dosing flow path closed.

Regarding the second embodiment, the controller may control the first valve 280 to open so as to allow excess build material and fresh build material to flow simultaneously along the supply flow path and the excess return flow path. In absence of the optional second valve 260, or with the second valve present and open, excess build material may be readily returned as soon as it falls into the excess return chamber 60 and to be mixed into the fresh supply material as it travels through the pump 90. With the second valve 260 present, the controller 100 may control the first and second valves so as to control the flow of excess return build material and supply build material independently from one another.

A section between the overflow or bypass and the build material pump may be restricted so as to provide a higher flow resistance to the flow of build material compared to the flow from the excess return chamber to the pump. For example, the first valve 280, the second valve 260 and/or sixth valve 240 may be variable valves. With regard to the first embodiment, the controller 100 may be configured to control the sixth valve 240 to be partially open, and the second valve 260 to be fully open, so as to apply a higher flow resistance to the flow of oversupply build material through the oversupply return flow path compared to the flow resistance to the flow of excess build material along the excess return flow path. Regarding the first embodiment and its variants, the first valve 280 may only be partially open so as to restrict the flow and generate a higher flow resistance to the flow of fresh build material through the supply flow path compared to the flow resistance to the flow of oversupply build material along the oversupply return flow path.

Regarding both embodiments and their variants, the supply flow path may be configured to have a higher flow resistance to build material flow than the excess return flow path. The first valve 280 may be a variable valve, and the controller 100 may be configured to control the first valve 280 to be only partially open so as to restrict the flow and generate a higher flow resistance to the flow of fresh build material through the supply flow path compared to the flow resistance to the flow of excess build material along the excess return flow path.

The flow of build material to the buffer tank in both embodiments and their respective variants may be prioritised, and the controller may be configured to apply the order of: firstly, allowing excess build material to flow along the excess return path, for example until the excess build material from the excess return chamber falls below a first predetermined level, by controlling the first valve to be at least partially closed; secondly, regarding variants of the first embodiment, allowing oversupply build material to flow along the oversupply return path while controlling the first and second valves to be at least partially closed, for example until the oversupplied build material in the overflow chamber 470 or in the bypass chamber 430 falls below a second predetermined level; and thirdly, allowing fresh build material to flow along the supply flow path while controlling the first valve to be at least partially open, for example until the build material in the buffer tank reaches a predetermined fill level.

In addition, with regard to the first embodiment and its variants, controlling the flow of build material to the buffer tank may comprise: firstly, controlling the second and fourth valves to open while controlling the first, third, fifth, and where present sixth, valves to be closed to allow excess build material to flow along the excess return flow path; secondly, where present, controlling the sixth and fourth valves to open while controlling the first, second, third, and fifth valves to be closed to return the oversupply amount of build material along the oversupply return flow path to the buffer tank; thirdly, controlling the first and fourth valves to open to replenish the buffer tank with fresh build material along the supply flow path while controlling the second, third, fifth, and where present sixth, valves to be closed.

The pump 90 may be operated to transport excess return build material from the excess return chamber 60 along the excess return flow path to the buffer tank 50 intermittently, and timed with respect to transporting oversupply build material along the oversupply flow path and fresh build material along the supply flow path, such that the amount of excess material entering the buffer tank remains constant over a given period of time. The build material pump may alternatively be controlled to operate continuously through the cycle of blocks 810 to 870. The excess return flow path and the supply flow path may be closed before opening the dosing flow path at block 810 so as to ensure that build material cannot immediately enter the dosing flow path without being mixed into the build material within the buffer tank. The dosing flow path may be closed and the supply flow path at least partially closed when opening the excess return flow path at block 840. The dosing flow path may be closed at least when opening the supply flow path at block 860. This improves the homogeneity of the build material within the buffer tank 50, although depending on how the excess and fresh build material is fed into the buffer tank, it may not be necessary to mix the added build material in before transporting build material along the dosing flow path from the buffer tank to the dosing device. For example, when build material is fed into the buffer tank at an upper section and exits into the dosing flow path at a lower section, it may not immediately reach the buffer tank outlet before being mixed with the existing material. The steps at blocks 840 and 860 may be applied simultaneously and may optionally comprise at least partially opening the respective flow paths so as to vary the flow resistances of the respective flow paths, such that excess build material flows along the excess return flow path to the buffer tank preferentially, or first, over fresh build material along the supply flow path from the supply tank 80, and so as to maintain a substantially consistent ratio of excess to fresh build material within the buffer tank.

In variants of the method, the steps at blocks 810 to 860 may be applied sequentially with each step present in each cycle. Alternatively, the step of dosing build material out of the dosing chamber at block 820 may be controlled independently from the remaining steps of managing the build material supply and return to and from the buffer tank 50, so that the build process for an object occurs over a fixed cycle duration and without delays. The step of receiving excess build material in the excess return chamber 60 at block 830 is dependent on block 820. Meanwhile, the block 840 of transporting excess build material along the excess return flow path, block 850, where present, of transporting oversupply build material along the overflow return path, the direct oversupply flow path or the recirculating oversupply flow path, and/or the block 860 of transporting fresh build material along the supply flow path may be controlled independently from the blocks 810 and 820. For example, these blocks may be applied sequentially over fewer cycles compared to the number of dosing cycles at block 810. Additionally, block 860 may be applied after repeating the step at blocks 840 and, where present, at block 850. At block 860, the fresh build material is transported to refill the buffer tank and to replace the amount lost to forming the layers.

The durations over which each flow path is to be open may be predefined, or dynamically controlled based on measurements of the build material level comprised within the various containers and chambers. The measurements may be provided by one or more build material level sensors, or mass sensors, arranged within and configured to measure the amount of build material in the buffer tank 50, and optionally further in one or more of the excess return chamber, the dosing chamber and, where present, the overflow chamber. The controller 100 may be configured to receive data from a build material level sensor, or a mass sensor, configured to measure the amount of build material in the buffer tank 50. Based on the measured amount, the controller 100 may control the timings and durations of transporting excess build material, overflow build material and fresh build material in to the buffer tank 50. For example, the timing of transporting build material from the various sources to the buffer tank may be adjusted during the build process in response to the measured amount of build material in the buffer tank.

Each layer, the deficit amount to the supply system of build material is the amount used for forming a layer over the work surface 8 and build area 12 over a layer cycle. The excess amount may be significantly smaller than the deficit amount of each layer cycle. A relatively larger amount of overflow build material may be generated compared to the excess amount. The controller may control the supply flow path, the excess return path and the oversupply flow path such that only excess and oversupply build material are returned alternately one or more times to the buffer tank 50 before opening the supply flow path to allow fresh build material from the supply tank to flow to the buffer tank. To reduce the duration over which the build material entering the buffer tank requires to be mixed into the existing amount of build material, alternatively, a supply cycle may comprise multiple instances, at fixed or variable durations, over which overflow material to be transported into the buffer tank, while there may only be one instance, or fewer than the multiple instances, over which excess material and/or fresh build material is transported into the buffer tank 50.

In a further variant of the method, blocks 810 and 820 may be applied each cycle. Blocks 840 and 860 may be applied alternately every cycle. Where block 850 is present, the three blocks may alternate over the cycles, such that each block is applied every third cycle:
Cycle 1: Open the dosing flow path to fill the dosing chamber; then close the dosing flow path (block 810) and open the excess return flow path. Close the excess return flow path (block 840). Dose the dosed amount (block 810).
Cycle 2: Open the dosing flow path to fill the dosing chamber; close the dosing flow path (block 810). Open the oversupply return flow path, close the oversupply return flow path (block 850). Dose the dosed amount (block 810).
Cycle 3: Open the dosing flow path to fill the dosing chamber; close the dosing flow path (block 810). Open the supply flow path, close the supply flow path (block 860). Dose the dosed amount (block 810).

The three cycles may then be repeated for the duration of the build process. As an example, for a cycle time of 10 seconds between repeated blocks 820, the dosing flow path may be opened for a duration of 5 seconds for each layer at block 810. In addition, one of the blocks 840 and 860 and, where present, of block 850, may be applied for 4 seconds each cycle and in an alternating fashion so that each block is applied every second layer, or every third layer where block 850 is present.

### Buffer Tank

In the block charts described herein, a common inlet flow path 130_IN from the group of inlet valves 310 into the pump 90 is shown, and a common outlet flow path 130_OUT out of the pump 90 into the group 320 of outlet valves outlet is illustrated; instead, the pump may comprise multiple inlets and outlets to allow the flow paths to be grouped differently or provide for individual flow paths into and out of the pump.

Furthermore, the valves as illustrated may be provided in the form of 2, 3, or 4-way valves, having more than one inlet and one outlet on the pump inlet side, and more than one outlet on the pump outlet side. The valves may be one-directional or bi-directional valves, and/or they may be variable or simple ON/OFF valves. It has been found that for example butterfly valves may be adequately controlled in a variable position to tune the amount of build material flow through the various flow paths.

The pump may be operated continuously or be switched on only when one or more of a dosing flow path, excess return flow path, oversupply return flow path and supply flow path is caused to open. In a preferred method of operation, the pump may be operated continuously.

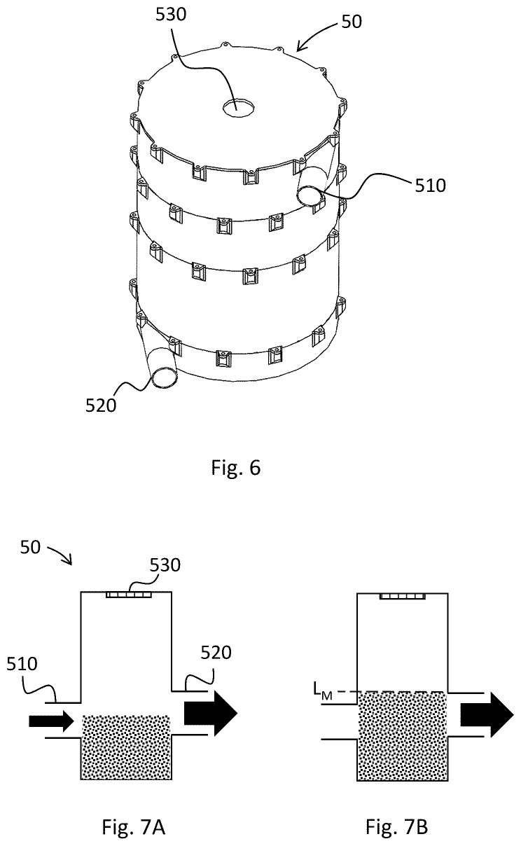

FIG. 6 is a 3D view of an example of a buffer tank in the form of a cylindrical container 50 having an upper infeed 510 and a lower outlet 520. The top surface of the container 50 comprises a vent 530 comprising a filter mesh configured to release gas from the container while preventing build material to exit through the vent. The infeed 510 and outlet 520 are arranged at a tangential direction to the circumference of the container. When the pump 90 is operated, build material is transferred under pressure via infeed 510 into the container 50 at a tangential angle to the circumference, such that build material introduced into the container is transported in a circulating manner. The outlet is arranged such that the powder material circulating along the inner container walls is transported out of the container along the direction of circulation within the container. Any excess gas or air is released via the vent 530. Thus the pump action may be used to mix the build material transferred into the buffer tank 50 into the resident build material to create a homogeneous mixture, and to maintain the build material in a free flowing state before it is caused to flow through the outlet 520 towards the dosing chamber 410. Additionally, or instead, an agitator may be provided inside the buffer tank 50 so as to mix the build material and maintain it in a free flowing state.

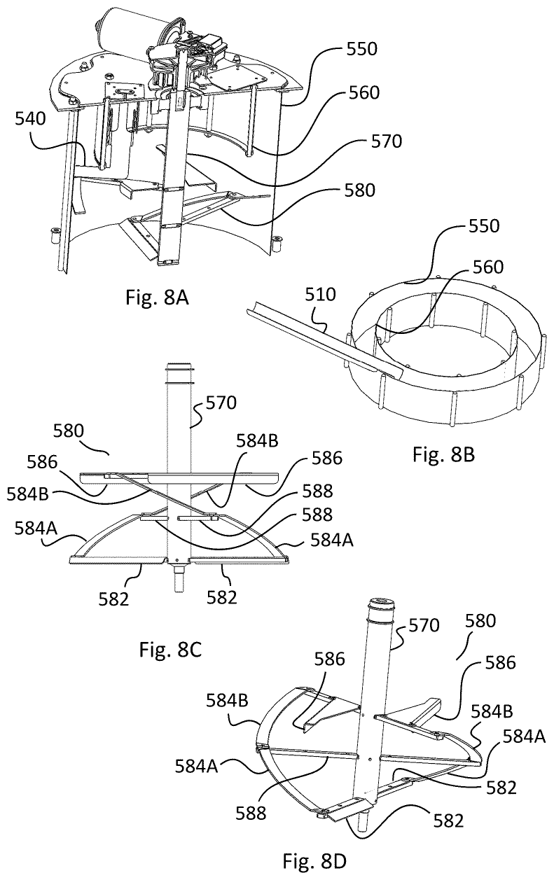

FIGS. 8A to 8D are 3D illustrations of an implementation of a mixing buffer tank 50 of FIG. 6. FIG. 8A is a cut through along the axis of outer cylinder wall 550 of the buffer tank. Along the axis, a rotational shaft 570 supports a mixing device 580 arranged at the lower section of the buffer tank interior configured to lift the build material from the bottom of the tank and mix and agitate it to keep it in a free flowing, homogeneous state. The top section of the buffer tank comprises a partial inner wall 560, thus creating a double wall for the upper portion of the tank. The partial inner wall 560 provides an inlet corridor for buffer tank inlet 510 shown in more detail in FIG. 8B. As build material is pumped into the buffer tank at a tangential angle to the outer and inner walls and along the corridor, the generation of build material dust within the buffer tank 50 is reduced. This variant of the buffer tank may not require a filtered vent since the outlet is shielded from powder dust. The build material falls downwards towards the floor of the buffer tank and is mixed into the resident build material by rotating the mixing device 580, illustrated in a side view mounted on the rotational shaft 570 in FIG. 8C, and in a 3D view in FIG. 8D. The mixing device comprises lifting blades 582 extending along the radial direction from the shaft for lifting the build material off the floor of the buffer tank. Helical frame sections 584A and 584B fixed to the shaft 570 by horizontal struts 588 connect the lower portion with the lifting blades to an upper mixing portion comprising churning blades 586 that transport the lifted build material towards the shaft. The buffer tank 50 may thus be arranged to continuously mix the build material and to prevent the generation of dust due to filling build material through the inlet 510 with a build material pump.

The buffer tank may further comprise a fill level sensor that detects when a fill level has been reached. FIG. 8A illustrates a mechanical version of a fill level sensor 540 in which a paddle extends from a mechanical switch from an upper tank portion vertically downwards into the tank. The paddle is hinged at the switching portion such that when the build material reaches the fill level, it pushes against the paddle and swings it from its vertical position to an angled position. This switches the switch so as to allow detection that the fill level has been reached. The controller coupled to the fill level sensor may close off the fill path into inlet 510 upon receiving a signal from the switch that the fill level has been reached.

FIG. 7A illustrates a build container having an inlet 510 arranged at a position lower than an outlet 520. In addition, the inlet 510 may have a higher flow resistance than the outlet 520. As build material enters the buffer tank 50, the build material level rises inside and begins to cover the inlet area into the buffer tank. At a predetermined maximum level LM, the amount of the build material inside the buffer tank is sufficient to provide a blocking flow resistance to further build material entering the buffer tank 50. Such an arrangement may provide a self regulating build material level within the buffer tank. The level LM may be predefined by providing a suitable flow resistance through the inlet pipe 510. Any overpressure of gas may exit through the top vent 530.

The buffer tank may therefore be configured so as to mix build material by comprising mechanical stirring means and/or comprising an inlet and outlet arranged such that when the controller causes build material to flow into the buffer tank, the build material is mixed by the compressed gas pressure of the pump. This may further keep the build material in a fluidised state. The inlet into the buffer tank may be arranged to cause a vortical flow inside the buffer tank such that the bursts of gas and build material from the pump may be introduced into the buffer tank such that mixing the added build material into the existing build material inside the buffer tank may be achieved purely by the action of the pump, and such that step (e) may comprise operating the build material pump so as to mix the build material in the buffer tank. The buffer tank may comprise a fill level sensor configured to detect a fill level of build material inside the buffer tank, and wherein the controller is configured to open and shut the supply flow path based on the detected level of build material inside the buffer tank. The controller 100 may be configured to control the components of the material supply systems described herein so as to carry out the method and its variants described herein.

The buffer tank may further be heated by for example placing conductive heat foils around the outer walls and/or by passing heated gas through the buffer tank in addition to the pump flow, for example by percolating heated gas through the build material from the bottom of the tank.

1. A build material supply system for an apparatus for the layerwise manufacture of 3D objects from build material, the build material supply system comprising:
a dosing device configured to supply a dosed amount of build material to a work surface of the apparatus, the dosed amount comprising a layer amount and an excess amount surplus to forming the layer;
a buffer tank configured to mix build material for supplying to the dosing device;
an excess return chamber for receiving excess build material from a distribution device;
a supply tank for holding fresh build material for replenishing the buffer tank;
a build material pump for transporting build material within the build material supply system; and
a controller;
wherein an inlet of the build material pump is coupled to the supply tank via a first valve, to the excess return chamber via a second valve, and to the buffer tank via a third valve; and
wherein an outlet of the pump is coupled to the buffer tank via a fourth valve and to an inlet of the dosing device via a fifth valve;
wherein the controller is coupled to the build material pump, and the first, second, third, fourth and fifth valves, and, so as to control the amount of fresh build material compared to the excess amount of build material transported into the buffer tank, the controller is configured to:
control the first, second and fourth valves to close, the third and fifth valves to open, and the pump to operate, to allow build material to flow along a dosing flow path from the buffer tank through the pump to the dosing device;
control the third and fifth valves to close, the first and fourth valves to open, and the pump to operate to allow fresh build material to flow along a supply flow path from the supply tank through the pump and into the buffer tank; and
control the third and fifth valves to close, the second and fourth valves to open, and the pump to operate to allow excess build material to flow along an excess return flow path from the excess return chamber through the pump and into the buffer tank.

2. The build material supply system of claim 1, wherein the dosing device comprises a dosing chamber coupled to the outlet of the pump and configured to receive build material from the buffer tank via the pump; the dosing device further comprising an overflow chamber coupled to the dosing chamber and configured to receive an oversupply amount of build material transferred from the buffer tank to the dosing chamber when the build material in the dosing chamber reaches a predefined level; wherein the overflow chamber is coupled to the inlet of the pump via a sixth valve, and wherein the controller is configured to control the third and fifth valves to close, the sixth and fourth valves to open and the pump to operate to allow oversupplied build material to flow from along an oversupply return flow path from the overflow chamber through the pump to the buffer tank.

3. The build material supply system of claim 1, wherein the dosing device comprises a dosing chamber, and a bypass chamber having an inlet and a bypass outlet at either end of an intermediate section, the intermediate section comprising one or more intermediate outlets, wherein the bypass inlet is coupled to the outlet of the pump via the fourth valve and the bypass outlet is coupled to the inlet of the buffer tank, and wherein the dosing chamber comprises one or more dosing chamber inlets configured to receive build material from the bypass chamber and coupled to the one or more intermediate outlets to form one or more intermediate flow paths; such that when the controller controls the first, second and fourth valves to close and the third and fifth valves to open, and the pump to operate, build material is caused to flow along the dosing flow path from the buffer tank through the pump to the bypass chamber of the dosing device and along the one or more intermediate flow paths from the bypass chamber to the dosing chamber so as to supply build material from the buffer tank to the dosing chamber, and an oversupply build material to return along a direct oversupply return flow path from the bypass chamber direct to the buffer tank.

4. The build material supply system of claim 3, wherein the bypass outlet is coupled to the inlet of the buffer tank via a sixth valve; such that when the controller controls the first, second and fourth valves to close and the third, fifth and sixth valves to open, and controls the pump to operate, build material is caused to flow along the dosing flow path and the one or more intermediate flow paths, and oversupply build material is caused to return to the buffer tank along the direct oversupply return flow path.

5. (canceled)

6. A build material supply system for an apparatus for the layerwise manufacture of 3D objects from build material, the build material supply system comprising:
a dosing device configured to supply a dosed amount of build material to a work surface of the apparatus, the dosed amount comprising a layer amount and an excess amount surplus to forming the layer;
a buffer tank configured to mix build material for supplying to the dosing device;
an excess return chamber for receiving excess build material from a distribution device;
a supply tank for holding fresh build material for replenishing the buffer tank;
a build material pump for transporting build material within the build material supply system; and
a controller;
wherein an inlet of the build material pump is coupled to the supply tank via a first valve and to an outlet of the excess return chamber; an outlet of the pump is coupled to an inlet of the buffer tank; and an outlet of the buffer tank is coupled to an inlet of the dosing device;
wherein the controller is coupled to the pump and the first valve and, so as to control the amount of fresh build material compared to the amount of excess build material transported into the buffer tank, the controller is configured to:
control the first valve to open and the pump to operate to allow fresh build material to flow along a supply flow path from the supply tank through the pump and into the buffer tank; and
operate the pump to allow excess build material to flow along an excess return flow path from the excess return chamber through the pump and into the buffer tank.

7. The build material supply system of claim 6, wherein the inlet of the pump is coupled to the excess return chamber via a second valve, and wherein the controller is coupled to the second valve.

8. The build material supply system of claim 6, wherein the dosing device comprises a dosing device inlet configured to receive build material from the outlet of the buffer tank, wherein the controller is coupled to the dosing device and configured to control the dosing device to release the dosed amount.

9. The build material supply system of claim 6, wherein the controller controls the first valve to close to shut off the supply flow path and to control the pump to operate, and optionally controls a second valve coupling the inlet of the pump to the excess return chamber to open, to allow the excess build material to flow along the excess return flow path.

10. The build material supply system of claim 7, wherein the controller controls the first and second valves to open so as to allow excess build material and fresh build material to flow simultaneously along the supply flow path and the excess return flow path.

11. The build material supply system of on claim 2, wherein the controller controls the first, second and fourth valves to open so as to allow excess build material and fresh build material to flow simultaneously along the supply flow path and the excess return flow path, and wherein the controller further controls the sixth valve to open to allow oversupply build material to flow from the overflow chamber into the buffer tank simultaneously with the excess build material and fresh build material while controlling the third and fifth valves to close to shut off the dosing flow path.

12. (canceled)

13. The build material supply system of claim 10, wherein the supply flow path is configured to have a higher flow resistance to build material flow than the excess return flow path.

14. The build material supply system of claim 10, wherein the first valve is a variable valve, wherein the controller is configured to control the first valve to be partially open so as to apply a higher flow resistance to the flow of fresh build material through the supply flow path compared to the flow resistance to the flow of excess build material along the excess return flow path.

15. The build material supply system of claim 6, wherein the controller is configured to prioritise the flow of build material to the buffer tank by applying the order of: firstly, allowing excess build material to flow along the excess return path by controlling the first valve to be at least partially closed; secondly, allowing fresh build material to flow along the supply flow path while controlling the first valve to be at least partially open.

16. The build material supply system of claim 6, wherein the buffer tank comprises a fill level sensor configured to detect a fill level of build material inside the buffer tank, and wherein the controller is configured to open and shut the supply flow path based on the detected level of build material inside the buffer tank.

17. A method of transporting build material through a build material supply system of an apparatus for the layerwise manufacture of 3D objects from build material, the method comprising:
(a) operating a build material pump while opening a dosing flow path, from a buffer tank to a dosing device, to transport build material from the buffer tank to the dosing device;
(b) dosing a dosed amount of build material to a work surface of an apparatus, the dosed amount comprising a layer amount for forming a layer and an excess amount surplus to forming a layer;
(c) receiving excess build material within an excess return chamber;
(d) operating the build material pump while opening an excess return flow path to return excess build material from the excess return chamber to the buffer tank;
(e) operating the build material pump while opening a supply flow path, from a supply tank to the buffer tank, to transport build material from a supply tank to the buffer tank, until either a predetermined fill duration has passed or upon detecting that the level of build material in the buffer tank has reached a predefined fill level; and
(f) mixing the excess amount with the build material in the buffer tank.

18. (canceled)

19. The method of claim 17, comprising:
closing the excess return and supply flow path before opening the dosing flow path at step (a), closing the dosing flow path and at least partially closing the supply flow path when opening the excess return flow path at step (d), and closing at least the dosing flow path when opening the supply flow path at step (e); and/or
detecting a fill level of build material in the buffer tank and/or an excess build material level in the excess return chamber, and controlling a duration at step (d) over which the excess return path is open and/or a duration at step (e) over which the supply path is open.

20. (canceled)

21. The method of claim 17, wherein the build material transported to the dosing device at step (a) comprises an oversupply amount of build material; wherein the step (b) further comprises a step (b1) of allowing the oversupply amount to flow out of the dosing device and a step (b2) of operating the pump while opening a further flow path from the dosing device to the buffer tank to return the oversupply amount to the buffer tank.

22. (canceled)

23. The method of claim 17, wherein excess build material at step (d) is returned to the buffer tank before transporting fresh build material from the supply tank to the buffer tank at step (e).

24. The method of claim 17, wherein the steps (d) and (e) are applied simultaneously, and optionally comprise at least partially opening the respective flow paths so as to vary the flow resistances of the respective flow paths such that the amount of excess build material and fresh build material flowing into the buffer tank is at a predefined ratio.

25. The method of claim 24, wherein for a plurality of repeats of steps (a) to (f), step (d) and step (e) are controlled such that the predefined ratio remains substantially constant over the plurality of repeats.
